(19) United States
(12) Patent Application Publication
(10) Pub. No.: US 2012/0249445 A1
(43) Pub. Date: Oct. 4, 2012

(54) ELECTRONIC DEVICE

(75) Inventors: Hiromichi Suzuki, Hamura-shi (JP); Takashi Minemura, Oume-shi (JP); Yuji Nakajima, Nishitama-gun (JP)

(73) Assignee: KABUSHIKI KAISHA TOSHIBA, Tokyo (JP)

(21) Appl. No.: 13/346,007

(22) Filed: Jan. 9, 2012

(30) Foreign Application Priority Data
Mar. 30, 2011 (JP) 2011-076418

(51) Int. Cl. G06F 3/041

(52) U.S. Cl. 345/173

(57) ABSTRACT

One embodiment provides an electronic device including: a connection portion; a first housing rotatably connected to the connection portion; a first display portion provided in the first housing; a first translucent portion having translucency and covering the first display portion, the first translucent portion including a first detection portion configured to detect a touch operation; a second housing rotatably connected to the connection portion; a second display portion provided in the second housing; and a second translucent portion having translucency and covering the second display portion, the second translucent portion including a second detection portion configured to detect a touch operation, wherein a front surface of the first translucent portion and a front surface of the second translucent portion are arranged substantially on the same plane when the first housing and the second housing are in an unfolded position.

### CROSS-REFERENCE TO RELATED APPLICATION(S)

This application claims priority from Japanese Patent Application No. 2011-076418 filed on Mar. 30, 2011, the entire contents of which are incorporated herein by reference.

### FIELD

Embodiments described herein relate generally to an electronic device.

### BACKGROUND

There is proposed a dual screen computer in which two housings having display panels respectively are connected to each other by hinges or the like. There is also proposed a technique in which a touch panel for detecting a touch operation is provided on a display panel so that a user's operation is applied to the displayed image.

It is preferable to allow a user to easily operate the aforementioned dual screen computer.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIGS. 1A to 1C illustrate an external appearance of a computer according to an embodiment.

FIG. 2 illustrates a system configuration of the computer.

FIG. 3 illustrates a functional configuration of the computer.

FIGS. 4A to 4E illustrate an operation input processing in the computer.

FIGS. 5A to 5D illustrate an operation input processing in the computer.

FIG. 6 illustrates a processing flow concerned with operation input processing in the computer according to an embodiment.

FIG. 7 illustrates another processing flow concerned with operation input processing in the computer.

### DETAILED DESCRIPTION

In general, one embodiment provides an electronic device including: a connection portion; a first housing rotatably connected to the connection portion; a first display portion provided in the first housing; a first translucent portion having translucency and covering the first display portion, the first translucent portion including a first detection portion configured to detect a touch operation; a second housing rotatably connected to the connection portion; a second display portion provided in the second housing; and a second translucent portion having translucency and covering the second display portion, the second translucent portion including a second detection portion configured to detect a touch operation, wherein a front surface of the first translucent portion and a front surface of the second translucent portion are arranged substantially on the same plane when the first housing and the second housing are in an unfolded position.

Embodiments will be described below with reference the drawings.

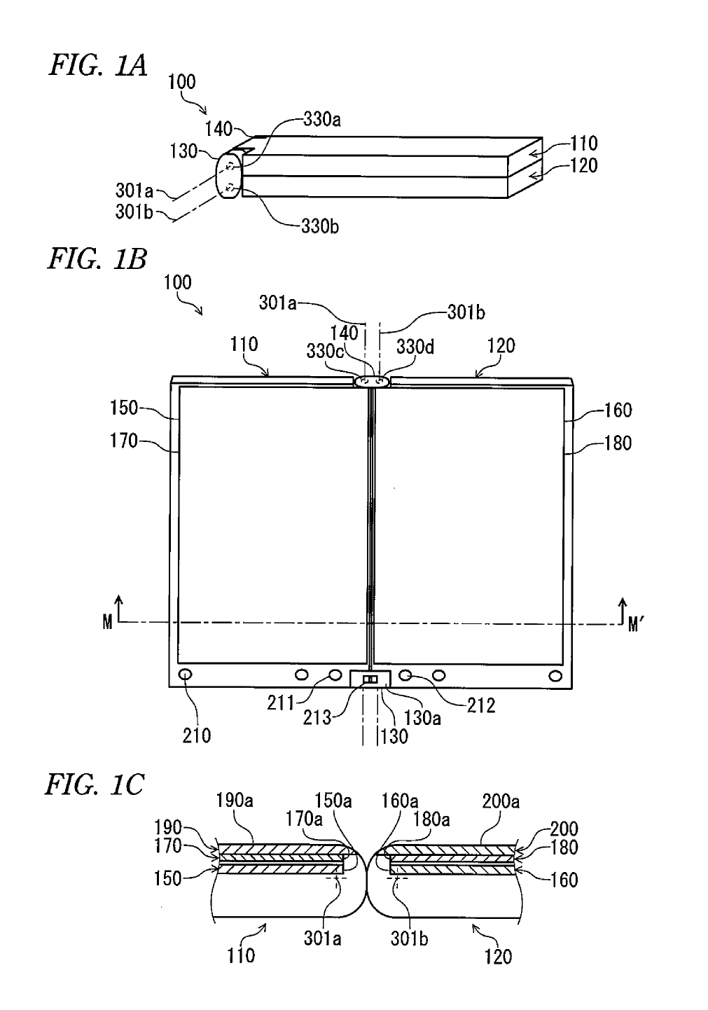

FIGS. 1A to 1C illustrate an electronic device, such as a foldable computer 100, according to an embodiment. For example, the computer 100 has a first housing 110, a second housing 120, connection portions 130 and 140, a first display panel 150, a first touch panel 170, a second display panel 160 and a second touch panel 180.

The first housing 110 and the second housing 120 are connected to each other by the connection portions 130 and 140. The first housing 110 is connected to the connection portion 130 so that the first housing 110 can rotate on a shaft portion 330a having a shaft 301a as an axis whereas the second housing 120 is connected to the connection portion 130 so that the second housing 120 can rotate on a shaft portion 330b having a shaft 301b as an axis. The first housing 110 is connected to a connection portion 140 so that the first housing 110 can rotate on a shaft portion 330c having the shaft 301a as an axis whereas the second housing 120 is connected to the connection portion 140 so that the second housing 120 can rotate on a shaft portion 330d having the shaft 301b as an axis.

The first display panel 150 is provided in a surface of the first housing 110. The first display panel 150 faces the second housing 120 when the first housing 110 and the second housing 120 are folded, as shown in FIG. 1A. The first touch panel 170 is laminated on the first display panel 150 and configured to detect/accept a touch operation input to the image displayed on the first display panel 150. The second display panel 160 is provided in a surface of the second housing 120 so as to face the first housing 110 when the first housing 110 and the second housing 120 are folded. The second touch panel 180 is laminated on the second display panel 160 and configured to detect/accept a touch operation input to the image displayed on the second display panel 160.

A power button 210 for receiving an operation of powering on/off the computer 100 and an operation button 211 are provided in the first housing 110. An operation button 212 is provided in the second housing 120. An operation dial 213 is provided on a front surface 130a side of the connection portion 130 between the shaft portions 330a and 330b. For example, the operation dial 213 detects an operation of moving either left or right and a pushing operation.

The first housing 110 and the second housing 120 can take various angles with respect to the connection portion 130. For example, the first housing 110 and the second housing 120 can be folded into a close state as shown in FIG. 1A, and can be unfolded via the connection portion 130 into an open state in which the first display panel 150 and the second display panel 160 are exposed to the outside and panel members extend substantially on the same plane with each other as shown in FIG. 1B.

FIG. 1C cross-sectionally illustrates the computer 100 along an M-M′ section in FIG. 1B. The translucent first and second touch panels 170 and 180 are provided on outer sides (exposure sides) of the first and second display panels 150 and 160, respectively. Translucent panels 190 and 200 are laminated on outer sides of the first and second touch panels 170 and 180, respectively. That is, the display panels 150 and 160 are covered with the translucent panels including the touch panels, respectively. For example, the display panels 150 and 160 may be general rigid display modules, or flexible sheet displays. Translucent members covering the display panels 150 and 160 may be flexible members such as translucent sheets. For example, a front surface 190a of the translucent panel 190 and a front surface 200a of the translucent panel 200 are arranged (adjacently) on substantially the same plane so as to be slightly separated with a distance or to abut on each other substantially when the first housing 110 and the second housing 120 are unfolded.

An end portion 150a of the first display panel 150 and an end portion 160a of the second display panel 160 may be close to each other within a predetermined distance when the first and second housings 110 and 120 are unfolded. Similarly, an end portion 170a of the first touch panel 170a and an end portion 180a of the second touch panel 180 may be close to each other within a predetermined distance when the first and second housings 110 and 120 are unfolded. The term “predetermined distance” means herein a distance allowing a user to touch both the first and second touch panels 170 and 180 with user's finger when the first and second housings 110 and 120 are unfolded, that is, means a distance not longer than the width (e.g. about 1 cm) of user's finger touching a plane. Preferably, the predetermined distance may be set to be shorter.

For facilitating the operation of touching both the first and second touch panels 170 and 180 with user's finger, any protrusive member may be removed between the front surface 190a of the translucent panel 190 and the front surface 200a of the translucent panel 200 at least when the first and second housings 110 and 120 are unfolded. For example, the front surface 190a and the front surface 200a may be closely arranged with interposition of a space. Or, even when a protrusive member is provided, the protrusive member may be made low enough so as not obstruct the user's touch operation. When the front surface 130a of the connection portion 130 is located substantially on the same plane with the front surfaces 190a and 200a in the open state, disturbance of a user's operation may be suppressed. For example, the front surface 130a may be located about 3 mm or less up/down from the plane on which the front surfaces 190a and 200a are located in the open state.

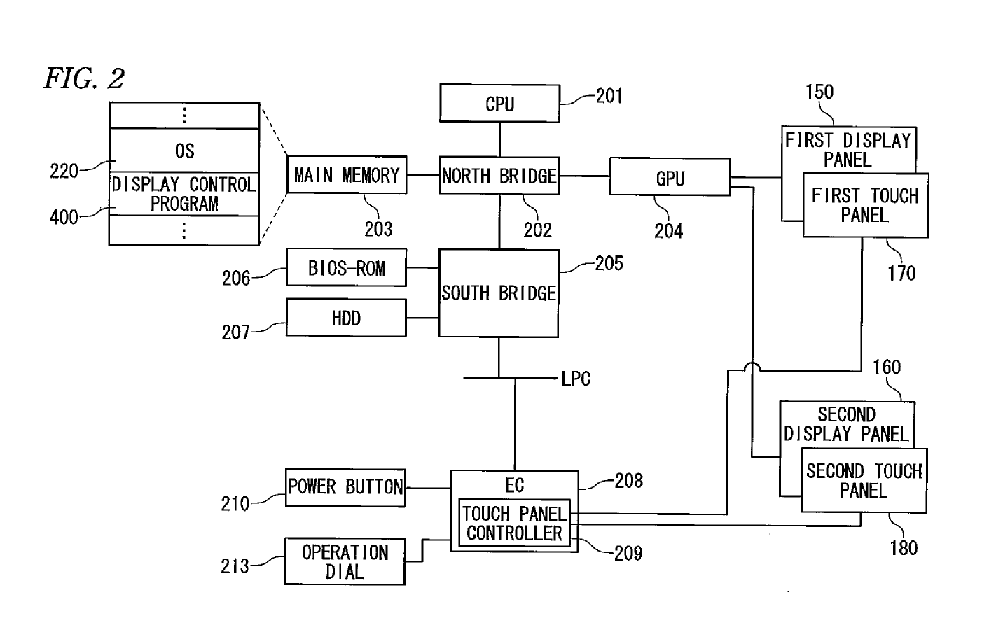

An example of system configuration of the computer 100 will be described below with reference to FIG. 2. The computer 100 has a CPU 201, a north bridge 202, a main memory 203, a GPU 204, a south bridge 205, a BIOS-ROM 206, an HDD 207, an embedded controller (EC) 208, a touch panel controller 209, a power button 210, an operation dial 213, a first display panel 150, a first touch panel 170, a second display panel 160, a second touch panel 180 etc.

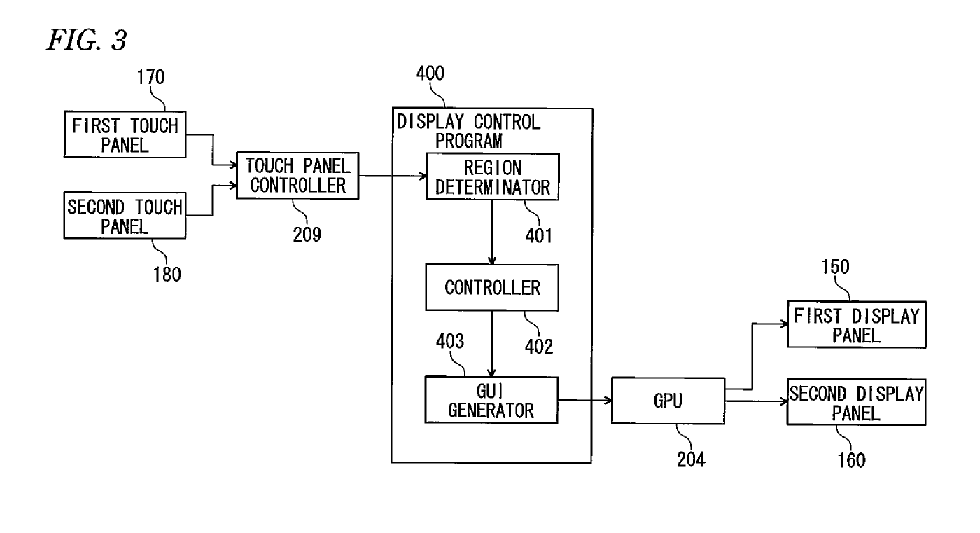

The CPU 201 controls operation of the computer 100. The CPU 201 loads various programs such as an operating system (OS) 220, a display control program 400, etc. into the main memory 203 and executes the various programs. The display control program 400 will be described later with reference to FIGS. 3 to 7.

The north bridge 202 is a bridge device which connects the CPU 201 and the south bridge 205 to each other. The north bridge 202 has a built-in memory controller which controls the main memory 203. Also, the north bridge 202 performs communication with the GPU 204 and controls the GPU 204 to execute image processing in accordance with an instruction given from the CPU 201.

The GPU 204 operates as a display controller for the first and second display panels 150 and 160 which form a display portion of the computer 100. The GPU 204 converts video data inputted from the CPU 201 into a video signal having a format displayable on display devices such as the display devices 150 and 160, and outputs the video signal to the display panels 150 and 160. The display panels 150 and 160 display video in accordance with the video signal outputted from the GPU 204.

The south bridge 205 functions as a controller for respective devices on a PCI (Peripheral Component Interconnect) bus and various devices on an LPC (Low Pin Count) bus. The BIO-ROM 206, the HDD 207, etc. are connected to the south bridge 205. The south bridge 205 has a built-in IDE (Integrated Drive Electronics) controller which controls the HDD 207.

The BIOS-ROM 206 stores a BIOS (Basic Input/Output System) which is a program for controlling hardware of the computer 100. The HDD 207 is a storage medium which stores various programs such as the operating system (OS) 220, the display control program 400, etc. The HDD 207 further stores image data such as photographs.

The EC 208 is connected to the south bridge 205 through the LPC bus. The EC 208 has the touch panel controller 209 which controls the first and second touch panels 170 and 180, and a controller (not shown) which controls operation input acceptance modules such as the power button 210 and the operation dial 213. The first touch panel 170, the second touch panel 180, the power button 210 and the operation dial 213 accept various external operation inputs. Each of the first and second touch panels 170 and 180 is configured to detect a touch region (touch position) on the touch panel, for example, by use of a resistive film type, a capacitive type, etc. The EC 208 outputs those operation input signals to the CPU 201.

The functional configuration of the display control program 400 will be described below with reference to FIG. 3. The display control program 400 has function blocks such as a region determinator 401, a controller 402, a GUI generator 403, etc.

Touch region information from the touch panel controller 209 is inputted to the region determinator 401. The touch region information includes coordinate data indicating touch regions (touch positions, touch ranges) detected by the first and second touch panels 170 and 180 respectively. The region determinator 401 determines which region (position) of the first and second panels 170 and 180 is subjected to an operation input (touch operation) based on the touch region information. When the coordinates of a touch operation move continuously, that is, when the first and second touch panels 170 and 180 are traced, the region determinator 401 detects the touch operation as a tracing operation.

When a predetermined region (range) in the first and second touch panels 170 and 180 is subjected to a tracing operation, the region determinator 401 outputs a touch region motion vector based on the tracing operation as vector information to the controller 402. That is, the region determinator 401 can treat a predetermined region (range) in the first and second touch panels 170 and 180 as a touch region. The region determinator 401 further determines which of the first and second touch panels 170 and 180 is subjected to an operation, and notifies the controller 402 of panel determination information indicating which panel is subjected to the operation.

When both the first and second touch panels 170 and 180 are subjected to a touch operation and touch regions in the two touch panels are close to each other, the region determinator 401 notifies the controller 402 of that fact.

When, for example, the first and second touch panels 170 and 180 are subjected to a tracing operation for movement from one of the first and second touch panels 170 and 180 to the other while the computer 100 executes processing concerned with electronic book contents such as display of electronic book contents, the region determinator 401 outputs area information indicating the area of the touch region based on the tracing operation in each of the first and second touch panels 170 and 180 to the controller 402.

The controller 402 executes processing in accordance with information inputted from the region determinator 401. When, for example, vector information is inputted from the region determinator 401, the controller 402 instructs the GUI generator 403 to generate a screen in which a cursor image is moved in the direction of movement indicated by the vector information.

The controller 402 executes so-called right click processing and left click processing in accordance with the panel indicated by the panel determination information. That is, when the touch operation is given on the left panel (e.g. the first touch panel 170) but is not detected anymore in a predetermined time while the touch region of the operation is not moved, the controller 402 executes left click processing. In the left click processing, for example, the controller 402 selects and decides an icon image, an image of a pull-down menu, etc. displayed in a position corresponding to the cursor image. The controller 402 instructs the GUI generator 403 to generate an image in accordance with the selection and decision. The controller 402 executes an application corresponding to the icon or the like by continuously executing left click processing in a predetermined time.

On the other hand, when the touch operation is given on the right panel (e.g. the second touch panel 180) but is not detected anymore in a predetermined time while the touch region of the operation is not moved, the controller 402 executes right click processing. In the right click processing, for example, the controller 402 instructs the GUI generator 403 to generate a menu image indicating an executable process for an icon image displayed in a position corresponding to the cursor image.

When the touch operation is given on both the first and second touch panels 170 and 180 and in regions close to each other, the controller 402 executes predetermined processing. When the tracing operation on the two touch panels in regions close to each other is given, for example, the controller 402 instructs the GUI generator 403 to display the screen while scrolling the screen up/down or scaling the screen up/down. When the two touch panels are subjected to a tracing operation but the operation on the two touch panel is detached from the two touch panels in a predetermined time without movement of the operation, for example, the controller 402 executes an enter process. For example, the term “enter process” means a process etc. for executing an application corresponding to the icon image displayed in a position corresponding to the cursor image in a desktop screen.

When, for example, panel determination information is inputted to the controller 402 while processing concerned with electronic book contents is executed, the controller 402 instructs the GUI generator 403 to generate a page screen corresponding to the panel indicated by the panel determination information. When area information is inputted to the controller 402, the controller 402 further executes a page turning process in accordance with the area information and instructs the GUI generator 403 to generate an image corresponding to the process.

The GUI generator 403 generates an image (screen) in accordance with the instruction given from the controller 402 and outputs data of the generated image to the GPU 204, so that the generated image is displayed on the display panels 150 and 160.

The aforementioned processing example of the display control program 400 is only one instance but has no intention of refusing any other processing. That is, the display control program 400 may execute predetermined processing in accordance with which region of which touch panel of the first and second touch panels 170 and 180 is subjected to a touch operation, whether the touch region is moved, the regions of the two touch panels close to each other are subjected to an operation, etc.

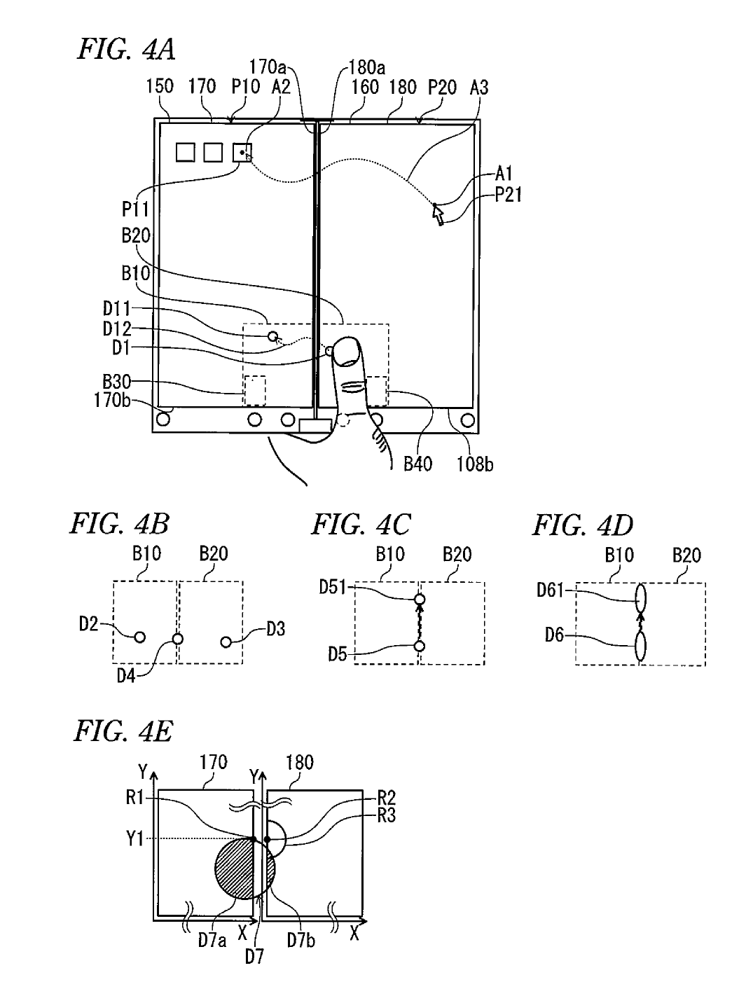

An example of processing in the case where the computer 100 is subjected to a touch operation will be described below with reference to FIGS. 4A to 4E. FIG. 4A illustrates an example of screens displayed by the display panels 150 and 160. Desk-top screens P10 and P20 are displayed by the display panels 150 and 160. An icon image P11 is disposed in the screen P10 whereas a cursor image P21 for selecting and deciding a target of operation is disposed in the screen P20.

For example, the region determinator 401 treats regions B10 and B20 of a predetermined region (range) as a region serving as a touch pad. That is, when a tracing operation starting from a region (range) D1 in the second touch panel 180 is given while the second display panel 160 displays the cursor image P21 in a position A1, the display panels 150 and 160 display the cursor image as it moves correspondingly with the tracing operation.

For example, the regions B10 and B20 are located in a region (range) where a user can touch with a finger while holding the computer 100 with a hand, as shown in FIG. 4A. That is, the region B10 spreads to an end portion 170a of the first touch panel 170 and an end portion 170b perpendicular to the end portion 170a, and the region B20 spreads to an end portion 180a of the second touch panel 180 and an end portion 180b perpendicular to the end portion 180a.

At least the portions directly touched by the user, that is, the front surface 190a covering the region B10 and the front surface 200a covering the region B20 may be arranged to be close to each other with interposition of a space. A protrusive member between the front surfaces (if any) may be made low enough so as not to obstruct the user's touch operation.

When the touch region moves from the region D1 along a locus D12 and reaches a region D11, the display panels 150 and 160 display screens in which the cursor image moves to a position A2 along a locus A3 correspondingly with the locus D12.

Processing in the case where the cursor image P21 is displayed in the position A2 corresponding to the icon image P 11 will be described with reference to FIG. 4B. When the first touch panel 170 is subjected to a touch operation in a region D2 in the condition that the cursor image P21 is located in the position A2, the controller 402 treats the touch operation as left click processing and selects the icon image P11.

When a touch operation in a region D3 is received in the condition that the cursor image P21 is located in the position A2, the controller 402 performs right click processing and displays the icon image P11 or an executable option menu for an application corresponding to the image.

When an operation in a region D4 is received, that is, regions of the first and second touch panels 170 and 180 close to each other are subjected to a touch operation, for example, the controller 402 executes an enter process to execute an application corresponding to the icon image P11.

When, for example, an operation input on the operation button 211 is received, the computer 100 may treat the operation as left click processing. Similarly, right click processing may be executed in accordance with an operation input on the operation button 212, and an enter process may be executed when a push operation on the operation dial 213 is received.

The computer 100 may execute left click processing when a touch operation in a region B30 of the first touch panel 170 is received, and the computer 100 may execute right click processing when a touch operation in a region B40 of the second touch panel 180 is received. In this case, the region determinator 401 need not treat the regions B10 and B20 as a touch region.

Another example of processing executed by the computer 100 will be described with reference to FIGS. 4C and 4D. When the touch panels 170 and 180 are subjected to a tracing operation in a range of from a region D5 to a region D51, that is, when the touch panels 170 and 180 are subjected to an operation of tracing regions close to each other, for example, the controller 402 performs a screen scrolling process. That is, in the case of the operation, the display panels 150 and 160 display an image while moving the image vertically.

Even in the case where the touch panels 170 and 180 are subjected to an operation of tracing regions close to each other, for example, the controller 402 executes a screen scaling-up/down process when the area of the touch region of the tracing operation or the length of each touch panel in a predetermined direction (e.g. Y direction) is not smaller than a predetermined threshold. The controller 402 switches scaling-up to scaling-down or scaling-down to scaling-up in accordance with the tracing direction of the tracing operation. That is, the controller 402 switches one of the scrolling process and the scaling-up/down process to another in accordance with parameters concerned with the size of the region (range) of the touch operation on the two touch panels.

An example of processing in which the region determinator 401 determines a touch operation as an operation in regions close to each other when the first and second touch panels 170 and 180 are subjected to the touch operation will be described with reference to FIG. 4E. Assume now that the touch panels 170 and 180 are subjected to a touch operation in a region D7. The first touch panel 170 is subjected to the touch operation in a region D7a. The region determinator 401 detects a coordinate value Y1 of a position R1 having the largest Y coordinate value in the end portion of the first panel 170 in the region D7a. The position having the coordinate value Y1 in the first touch panel 170 side end portion of the second touch panel 180 is a position R2. When a touch operation in a region R3 within a distance from the position R2 is received, the region determinator 401 determines this touch operation and the touch operation on the first touch panel 170 as touch operations close to each other.

The computer 100 may display an image indicating a region (range) of the regions B10 and B20 or the regions B30 and B40.

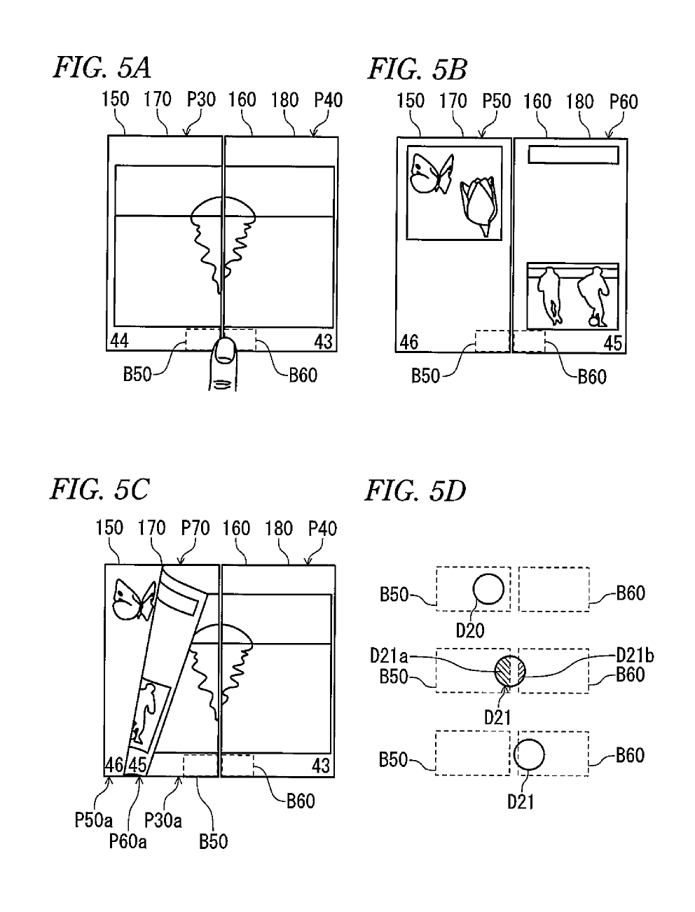

Another example of operation input processing executed by the computer 100 will be described below with reference to FIGS. 5A to 5D. FIGS. 5A to 5C show an example of a screen when, for example, the computer 100 displays electronic book contents.

FIG. 5A shows a state in which the first display panel 150 displays a screen P30 while the second display panel 160 displays a screen P40. When the first touch panel 170 is subjected to a touch operation in a predetermined region B50, the display panels 150 and 160 display next page screens P50 and P60 of electronic book contents as shown in FIG. 5B. When the second touch panel 180 is subjected to a touch operation in a predetermined region B60, the display panels 150 and 160 display previous page screens (not shown) of electronic book contents. The regions B50 and B60 extend to the opposite touch panel side end portions of the touch panels 170 and 180 respectively.

FIG. 5C shows an example of a screen in a page turning process of electronic book contents executed by the computer 100. The computer 100 executes a page turning process when, for example, the touch panels 170 and 180 are subjected to a tracing operation for movement from one of the touch panels 170 and 180 to the other. In the page turning process, the first display panel 150 displays a screen P70 of pages in the middle of page turning. The screen P70 includes a part P30a of a screen P30 displayed before the page turning process, and parts P50a and P60a of next page screens P50 and P60 which will be displayed after the page turning process.

An example of processing of the display control program 400 in the page turning process will be described with reference to FIG. 5D. Assume first that the first touch panel 170 is subjected to a touch operation in a region D20. When the operation performs tracing on the first touch panel 170 to touch the second touch panel 180 through a region D21 before reaching a region D22, the region determinator 401 determines the areas of the touch regions D21a and D21b on the touch panels 170 and 180. The GUI generator 403 generates a screen of a page turning amount corresponding to the area ratio of the touch panels 170 and 180. That is, the GUI generator 403 generates a screen in which the area of an image of a page which will be displayed next by the page turning process becomes large as the area ratio of the touch region of the second touch panel 180 becomes high. The region determinator 401 need not determine the area ratio of the touch regions. For example, the region determinator 401 may determine the ratio of widths (X coordinate widths in FIG. 4E) of the touch regions. That is, the region determinator 401 may determine the ratio of parameters concerned with the sizes of regions (ranges) of the touch operation at least on the two touch panels.

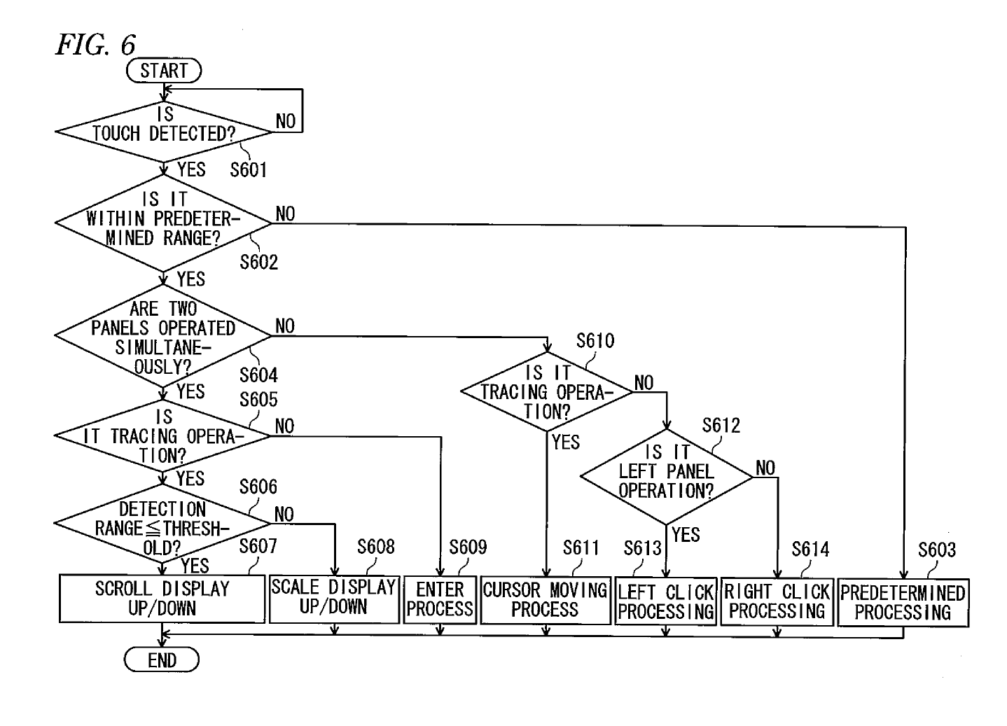

An example of a processing flow concerned with operation input processing executed by the computer 100 will be described below with reference to FIG. 6.

First, when at least one of the touch panels 170 and 180 is subjected to a touch operation (Yes in S601), the region determinator 401 determines whether the touch operation is given in a predetermine region or not (S602). When the touch operation is given out of the predetermined region (No in S602), the computer 100 executes predetermined processing (S603). The term “predetermined processing” mentioned herein means processing etc. generally executed by a computer having a touch panel. That is, when, for example, a touch operation on an icon image is received, the computer 100 starts up an application corresponding to the icon image.

On the other hand, when the determination in the step S602 concludes that the touch operation is given in the predetermined region (Yes in S602), the region determinator 401 determines whether the touch operation is given in regions of the touch panel 170 and 180 close to each other or not (S604). When the touch operation is a touch operation in regions close to each other (Yes in S604), the region determinator 401 determines whether the operation is a tracing operation or not (S605).

When the operation is a tracing operation (Yes in S605), the region determinator 401 determines whether a detection range of the touch region of the tracing operation is at most equal to a predetermined threshold or not (S606). When the detection range of the touch region is at most equal to the threshold (Yes in S606), the computer 100 displays a screen while scrolling the screen (S607). On the other hand, when the determination in the step S606 concludes that the detection range of the touch region is larger than the threshold (No in S606), the computer 100 displays a screen while scaling the screen up/down (S608).

When the determination in the step S605 concludes that the touch operation is detached from the touch panels in a predetermined time without movement of the touch operation (No in S605), the computer 100 executes an enter process to execute starting-up, etc. of an application (S609).

When the determination in the step S604 concludes that the touch operation is given on one of the touch panels 170 and 180 (No in S604), the region determinator 401 determines whether the operation is a tracing operation or not (S610). When the operation is a tracing operation, the computer 100 executes a cursor moving process to display motion images indicating movement of the cursor image on the display panels 150 and 160 (S611).

When the determination in the step S610 concludes that the operation is not a tracing operation (No in S610), the region determinator 401 determines which of the touch panels 170 and 180 is subjected to the operation (S612) and switches and executes one of left click processing and right click processing in accordance with which panel is subjected to the operation (S613 and S614).

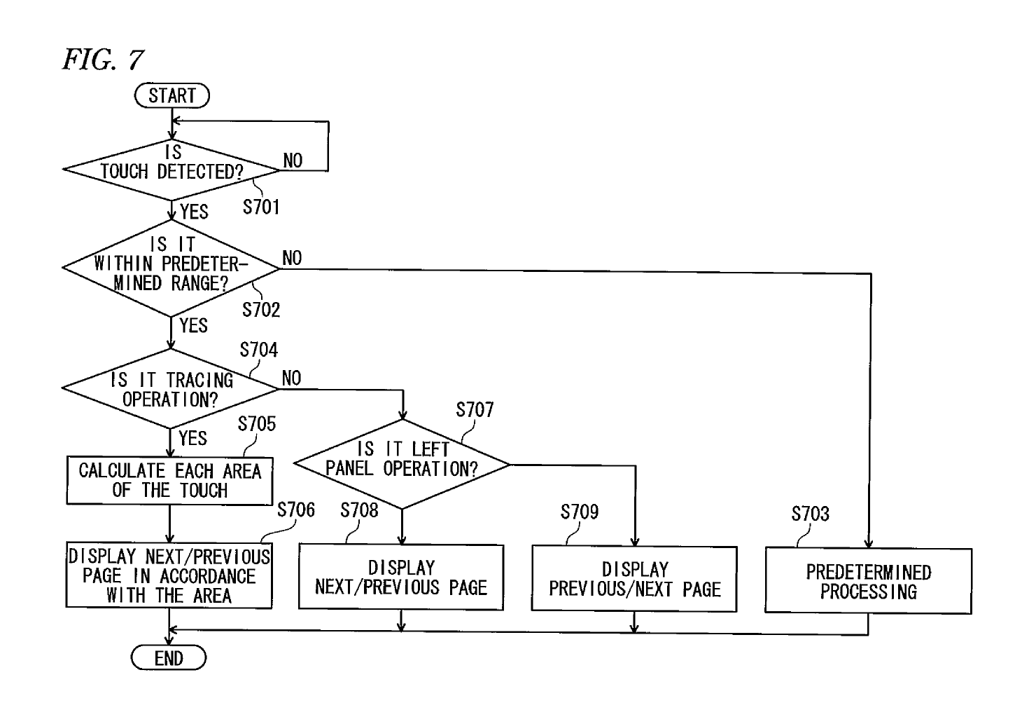

Another example of a processing flow of operation input processing executed by the computer 100 will be described below with reference to FIG. 7. This flow shows an example of a processing flow in the case where the computer 100 executes a program, for example, for displaying electronic book contents.

First, when a touch operation on at least one of the touch panels 170 and 180 is received (Yes in S701), the region determinator 401 determines whether the touch operation is given in a predetermined region or not (S702). When the touch operation is given out of the predetermined region (No in S702), the computer 100 executes such predetermined processing as generally executed by a computer having a touch panel (S703).

On the other hand, when the determination in the step S702 concludes that the touch operation is given in the predetermined region (Yes in S702), the region determinator 401 determines whether the operation is a tracing operation or not (S704). When the operation is a tracing operation (Yes in S704), the region determinator 401 calculates the area and width of the touch region of the tracing operation on each of the touch panels 170 and 180 (S705). Then, the computer 100 displays page contents of a next page or a previous page with an area corresponding to the area or width of the touch region in each of the touch panels 170 and 180 (S706).

On the other hand, when the determination in the step S704 concludes that the operation is not a tracing operation (No in S704), the region determinator 401 determines which of the touch panels 170 and 180 is subjected to the touch operation (S707) and displays a screen indicating contents of a next page or a previous page in accordance with which touch panel is subjected to the operation (S709).

Although some embodiments have been described, these embodiments are presented as instances but have no intention of limiting the scope of the invention. These embodiments can be carried out in other various modes, and various omissions, replacements and changes may be made without departing from the scope of the invention. For example, these embodiments may be applied on a cellular phone terminal or the like. These embodiments and modifications thereof will be covered by Claims.

1. An electronic device comprising:
a connector;
a first housing rotatably connected to the connector;
a first display provided in the first housing;
a first translucent portion configured to cover the first display, the first translucent portion comprising a first detect or configured to detect a touch operation;
a second housing rotatably connected to the connector;
a second display provided in the second housing; and
a second translucent portion configured to cover the second display, the second translucent portion comprising a second detector configured to detect a touch operation,
wherein a front surface of the first translucent portion and a front surface of the second translucent portion are arranged substantially on the same plane if the first housing and the second housing are in an unfolded position.

2. The device of claim 1,
wherein the first detector is located within a first distance from the second detector if the first housing and the second housing are in the unfolded position.

3. The device of claim 2,
wherein the first housing is rotatable around a first shaft portion, and
wherein the second housing is rotatable around a second shaft portion parallel to the first shaft portion.

4. The device of claim 2, further comprising:
an execution unit configured to execute a first processing if, while the first detector detects a touch operation in a first range, the second detector detects a touch operation in a second range close to the first range.

5. The device of claim 4,
wherein the execution unit executes the first processing in accordance with sizes of the first and second ranges.

6. The device of claim 5,
wherein the execution unit executes the first processing which varies according to whether or not a sum of the sizes of the first and second ranges is equal to or larger than a first threshold.

7. The device of claim 5,
wherein the execution unit executes the first processing in accordance with a ratio of the sizes of the first and second ranges.

8. The device of claim 4,
wherein the execution unit executes the first processing to display a first image on at least one of the first and second display portions.

9. The device of claim 3,
wherein a front surface of the connector is located substantially on the same plane with the front surface of the first translucent portion when the first and second housings are in the unfolded position.

10. The device of claim 9,
wherein the connector comprises an input portion provided on the front surface thereof and configured to accept an operation input.
